(19) United States
(12) Patent Application Publication
(10) Pub. No.: US 2024/0007498 A1
(43) Pub. Date: Jan. 4, 2024

(54) APPARATUS FOR PROVIDING MAIL SECURITY SERVICE USING HIERARCHICAL ARCHITECTURE BASED ON SECURITY LEVEL AND OPERATION METHOD THEREFOR

(71) Applicant: KIWONTECH CO., LTD., Seoul (KR)

(72) Inventor: Chung Han KIM, Seoul (KR)

(21) Appl. No.: 18/255,321

(22) PCT Filed: May 24, 2021
(86) PCT No.: PCT/KR2021/006395

§ 371 Date: May 31, 2023

(30) Foreign Application Priority Data
Dec. 21, 2020 (KR) 10-2020-0180096

(51) Int. Cl. H04L 9/40

(52) U.S. Cl. CPC H04L 63/145; H04L 63/1416; H04L 63/1433; H04L 63/20

(57) ABSTRACT

A method for operation of an apparatus for providing an e-mail security service according to an embodiment of the present invention comprises: a collection step of collecting mail information being transmitted and received between one or more user terminals; a security threat inspection step of processing step-by-step matching of a mail security process corresponding to the mail information, according to a preset security threat architecture, inspecting the mail information by the matching-processed mail security process, and storing and managing mail security inspection information according to the result of the inspection; a mail processing step of processing a mail status according to security threat determination information being acquired via analysis of the mail security inspection information and the mail information; and a record management step of storing and managing, as record information, the mail information which has been processed according to the security threat determination information.

### TECHNICAL FIELD

The present invention relates to an apparatus for providing an email security service and an operation method thereof, and more particularly, to an apparatus for providing an email security service using a hierarchical architecture based on security levels, and an operation method thereof, which can detect and block cyber threats such as malicious code infection through email, social engineering hacking, and the like.

### BACKGROUND ART

In today's society, dependency on cyberculture is increasing in all areas of social life around the world due to advancement in computers and information and communication technologies, and this trend is further accelerated. Recently, as 5G mobile communication with ultra-high speed, ultra-low delay, and hyper-connectivity is commercialized and new services based thereon are introduced, cyber security is becoming more important.

Technical fields such as Internet of Things (IoT), cloud systems, big data, artificial intelligence (AI), and the like provide a new service environment in combination with the information and communication technologies. A system that provides such a service may be connected to a PC, a portable terminal device, or the like through an Internet network, a wireless network, or the like to be used in real life.

As the information and communication technologies connected to various terminal devices or communication devices are getting more closely related to real life in this way, cyber security threats with malicious intention using the technologies are increasing day by day. As sophisticated and advanced cyber security threats induce abnormal execution of information and communication terminal devices of organizations, institutions, or individuals or induce human errors through forgery and alteration of management information, damage such as stealing and destroying information may be generated. In addition, information illegally stolen through the cyber security threats may also be used to commit monetary fraud crimes or other economic and social crimes.

An information protection system that protects and manages systemized information and communication technologies may be used to block and respond to the cyber security threats. The information protection system may be constructed according to the system type or technical features of the information and communication technologies and applied in steps to respond to various cyber threats.

Email systems used in the information and communication technologies may provide electronic mail service including a message body to send and receive messages using communication lines between users through computer terminals. At this point, emails may attach electronic files containing contents to be shared, and a link (URL; uniform resource locator) for connecting to a website may be written in the message body or inserted in the attached file.

In this way, an executable electronic file containing malicious codes may be attached or a URL that allows connection to a specific website may be inserted through the email system with a malicious intention. Through this, as email recipients are persuaded to execute the malicious codes or access a forged or altered website through the inserted URL, processing of information not intended by the user may be performed, and information can be stolen.

In order to respond to the email security threats that may induce economic and social damage and lead to various crimes, a ‘system for controlling and blocking electronic mail attached with malicious codes’ is disclosed in Korean Patent Registration No. 10-1595379. The registered patent describes a system for controlling and blocking electronic mail attached with malicious codes, and the system includes: a target system having a function of receiving electronic mail sent from an external server or a terminal and received via a firewall and a spam blocking device embedded with spam blocking software, a function of confirming whether the electronic mail has an attached file, transmitting the electronic mail to a mail server when there is no attached file, and preventing infection of a malicious code by blocking the electronic mail except for the types of attached files (document, compression, image) most frequently used for user's business purposes when there is an attached file, a function of transmitting the electronic mail to the mail server when the type of the attached file is an image since it cannot be infected with a malicious code as an image cannot be converted, and transmitting a notification mail to the user terminal, when the type of the attached file is a document, by selecting one or more among the electronic mail, messenger, mobile communication, and KakaoTalk in a way of converting the document into an unmodifiable PDF form to prevent the user terminal from being infected by a malicious code when the mail recipient clicks a URL reflected with a malicious code in the document, a function of decompressing the attached file and analyzing a file type when the type of the attached file is a compressed file, processing in the method described above when the type of the attached file is an image, converting the attached file into a PDF file and processing in the method described above when the type of the attached file is a document, performing inspection and treatment of malicious code infection in a Virtual BOX equipped with various types of malicious code treatment solutions, and sending a notification mail including a result thereof to the mail server by selecting one or more among electronic mail, messenger, mobile communication, and KakaoTalk when the type of the attached file is an execution file, and a function of sending an attached file that requires malicious code inspection, other than the execution file, to the Virtual BOX to inspect and treat the malicious code, and receiving a result thereof; a virtual box for receiving an execution file from the target system, which configures a virtualized environment as a separate system and mounts various types of malicious code treatment solutions to inspect and treat malicious codes hidden in the execution file, transfer a result thereof to the target system, and process restoration to an environment before the inspection; a mail server having a function of receiving electronic mail (including notification mail) from the target system and forwarding the electronic mail (including notification mail) to the user terminal; and the user terminal having a function of selecting, when a notification mail is received from the target system, permission or rejection of the original electronic mail through confirmation of the notification mail, and a function of confirming the received electronic mail after logging in, by the user.

However, the system for controlling and blocking electronic mail attached with malicious codes is limited to a response system that is on the receiving side of email. In addition, there is a limit in responding to the cyber security threats from the aspect of the internal side of an email management system and the aspect of processing the email in the user terminal device, in addition to the aspect of the sending side of the email.

In addition, since the system is limited to PDF conversion against malicious codes and forged and altered URLs embedded in the files attached to an email, there may be limitations in diagnosing and responding to threats such as a mail disguised with a similar domain, analysis of relationship that may launch social engineering attacks, and the like.

### DISCLOSURE OF INVENTION

### Technical Problem

Therefore, the present invention has been made in view of the above problems, and it is an object of the present invention to provide an apparatus for providing an email security service and an operation method thereof, which can response to cyber security threats and control and manage email systems step-by-step by using a hierarchical architecture based on security levels against the cyber security threats such as spam, hacking, fraud, and the like that can be considered from the aspect of incoming mail, outgoing mail, and mail processing in a system, a user terminal device, and the like.

### Technical Solution

To accomplish the above object, according to one aspect of the present invention, there is provided a method of operating an apparatus for providing an email security service, the method comprising: a collection step of collecting mail information transmitted and received between one or more user terminals; a security threat inspection step of processing step-by-step matching of a mail security process corresponding to the mail information, inspecting the mail information by the matching-processed mail security process, and storing and managing mail security inspection information according to a result of the inspection, on the basis of a preset security threat architecture; a mail processing step of processing a mail state according to security threat determination information acquired through analysis of the mail security inspection information and the mail information; and a record management step of storing and managing the mail information processed according to the security threat determination information as record information.

According to another aspect of the present invention, there is provided an apparatus for providing an email security service, the apparatus comprising: a collection unit for collecting mail information transmitted and received between one or more user terminals; a security threat inspection unit for processing step-by-step matching of a mail security process corresponding to the mail information, inspecting the mail information by the matching-processed mail security process, and storing and managing mail security inspection information according to a result of the inspection, on the basis of a preset security threat architecture; a mail processing unit for processing a mail state according to security threat determination information acquired through analysis of the mail security inspection information and the mail information; and a record management unit for storing and managing the mail information processed according to the security threat determination information as record information.

Meanwhile, the method according to an embodiment of the present invention for solving the problems may be implemented as a program for executing the method or a computer-readable recording medium in which the program is recorded.

### Advantageous Effects

According to an embodiment of the present invention, as emails are analyzed by classifying threats into a spam mail, an attached file containing malicious codes, a forged and altered URL, a similar domain, and fraudulent contents from the aspect of the receiving side, and the threats can be handled step-by-step, mails sent for malicious purposes can be blocked before the recipient opens or converted into a mail harmless to the system. In addition, damage can be prevented so that the emails may not be used for malicious purposes by detecting and blocking cyber security threats from the aspect of the sending side and detecting in advance potential threats such as being suspicious of information leakage or inconsistency of managed system access IP address information from the aspect of the internal side of an email management system. An email service that guarantees safe exchange and processing of information between users can be provided by controlling abnormal situations such as hacking, fraud, and spam that can be generated through an email system and preventing damage thereof in this way.

### BRIEF DESCRIPTION OF THE DRAWINGS

FIG. 1 is a conceptual view showing an entire system according to an embodiment of the present invention.

FIG. 2 is a block diagram showing an apparatus for providing a mail security service according to an embodiment of the present invention.

FIG. 3 is a block diagram for explaining in more detail some configurations of an apparatus for providing a mail security service according to an embodiment of the present invention.

FIG. 4 is a flowchart for explaining a method of operating an apparatus for providing a mail security service according to an embodiment of the present invention.

FIGS. 5A, 5B, and 5C are exemplary views for explaining an inspection method according to an architecture of a mail security service according to an embodiment of the present invention.

### BEST MODE FOR CARRYING OUT THE INVENTION

Hereinafter, only the principles of the present invention will be exemplified. Therefore, although not clearly described or shown in this specification, those skilled in the art will be able to implement the principles of the present invention and invent various devices included in the spirit and scope of the present invention. In addition, it should be understood that all conditional terms and embodiments listed in this specification are, in principle, clearly intended only for the purpose of understanding the concept of present invention, and not limited to the embodiments and states specially listed as such.

In addition, it should be understood that all detailed descriptions listing specific embodiments, as well as the principles, aspects, and embodiments of the present invention, are intended to include structural and functional equivalents of such matters. In addition, it should be understood that such equivalents include equivalents that will be developed in the future, as well as currently known equivalents, i.e., all devices invented to perform the same function regardless of the structure.

Accordingly, for example, the block diagrams in the specification should be understood as expressing the conceptual viewpoints of illustrative circuits that embody the principles of the present invention. Similarly, all flowcharts, state transition diagrams, pseudo code, and the like may be practically embodied on computer-readable media, and it should be understood that regardless of whether or not a computer or processor is explicitly shown, they show various processes performed by the computer or processor.

In addition, explicit use of the terms presented as processors, controls, or concepts similar thereto should not be interpreted by exclusively quoting hardware having an ability of executing software, and should be understood to implicitly include, without limitation, digital signal processor (DSP) hardware, and ROM, RAM and non-volatile memory for storing software. Other known common hardware may also be included.

The above objects, features and advantages will become more apparent through the following detailed description related to the accompanying drawings, and accordingly, those skilled in the art may easily implement the technical spirit of the present invention. In addition, when it is determined in describing the present invention that the detailed description of a known technique related to the present invention may unnecessarily obscure the gist of the present invention, the detailed description thereof will be omitted.

The terms used in this specification are used only to describe specific embodiments, and are not intended to limit the present invention. Singular expressions include plural expressions unless the context clearly dictates otherwise. It should be understood that in this specification, terms such as “comprise” or “have” are intended to specify existence of a feature, a number, a step, an operation, a component, a part, or a combination thereof described in the specification, not to preclude the possibility of existence or addition of one or more other features, numbers, steps, operations, components, parts, or combinations thereof.

Hereinafter, preferred embodiments of the present invention will be described in more detail with reference to the accompanying drawings. In describing the present invention, in order to facilitate the overall understanding, the same reference numerals are used for the same components in the drawings, and duplicate descriptions of the same components are omitted.

A ‘mail (email)’ used in this specification may collectively refer to terms such as electronic mail, web email, electronic mail, electronic mail materials, and the like exchanged between a user and a terminal device using a computer communication network through a client program installed in the terminal device or a website.

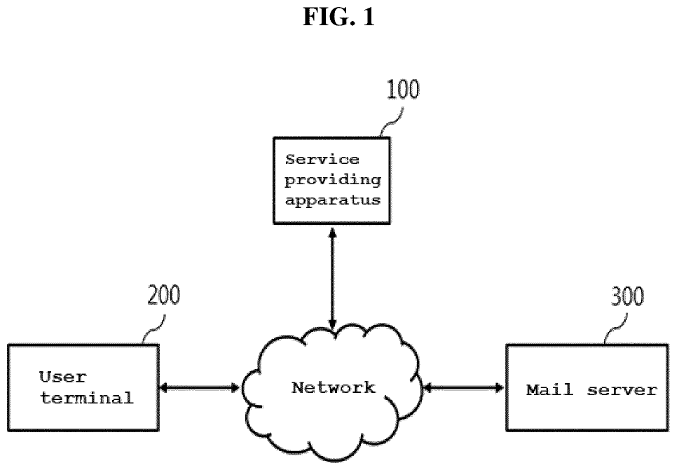

FIG. 1 is a conceptual view showing an entire system according to an embodiment of the present invention.

Referring to FIG. 1, a system according to an embodiment of the present invention includes a service providing apparatus 100, a user terminal 200, and a mail server 300.

More specifically, the service providing apparatus 100, the user terminal 200, and the mail server 300 are connected to a public network in a wired or wireless manner to transmit and receive data. The public network is a communication network constructed and managed by the country or a telecommunication infrastructure operator, and generally includes a telephone network, a data network, a CATV network, a mobile communication network, and the like, and provides connection services so that unspecified many people may access other communication networks or the Internet. In the present invention, the public network is described as a network.

In addition, the service providing apparatus 100, the user terminal 200, and the mail server 300 may include a communication module for communicating using a protocol corresponding to each communication network.

The service providing apparatus 100 may be connected to each user terminal 200 and the mail server 300 through a wired/wireless network to provide a mail security service, and devices or terminals connected to each network may communicate with each other through a preset network channel.

Here, each of the networks may be implemented as any one type of wired/wireless networks, such as a local area network (LAN), a wide area network (WAN), a value-added network (VAN), a personal area network (PAN), a mobile communication network, or a satellite communication network.

The service providing apparatus 100 described in this specification may provide a mail security service capable of detecting and blocking unintended execution of a program through a mail and attacks that lead to lowered data processing power, phishing scam, and the like of mail-related systems.

In addition, although the user terminal 200 described in this specification may include a personal computer (PC), a laptop computer, a mobile phone, a tablet PC, a Personal Digital Assistant (PDA), a Portable Multimedia Player (PMP), and the like, the present invention is not limited thereto, and the user terminal may be a device that can be connected to the service providing apparatus 100 and the mail server 300 through a public network or a private network.

In addition, each device may be a device of various types capable of inputting and outputting information by driving an application or browsing the web. Particularly, it is general that user terminals 200 may be connected to the service providing apparatus 100 through an individual security network.

The mail server 300 is a system that relays and stores electronic mail contents so that a user may send a mail written through the user terminal 200 or receive a mail written by a counterpart through the user terminal 200. The mail server 300 may communicate using a pre-set protocol according to the purpose of receiving and sending mails.

Generally, Post Office Protocol 3 (POP3) and Internet Message Access Protocol (IMAP) may be used as the protocol when a mail is received. In addition, Simple Email Transfer Protocol (SMTP) may be used as the protocol when sending a mail. In this way, the mail server 300 may be configured to operate as a server system for processing mail transmission and reception. In addition, the mail server 300 may be subdivided into a mail receiving server and a mail sending server to provide their functions.

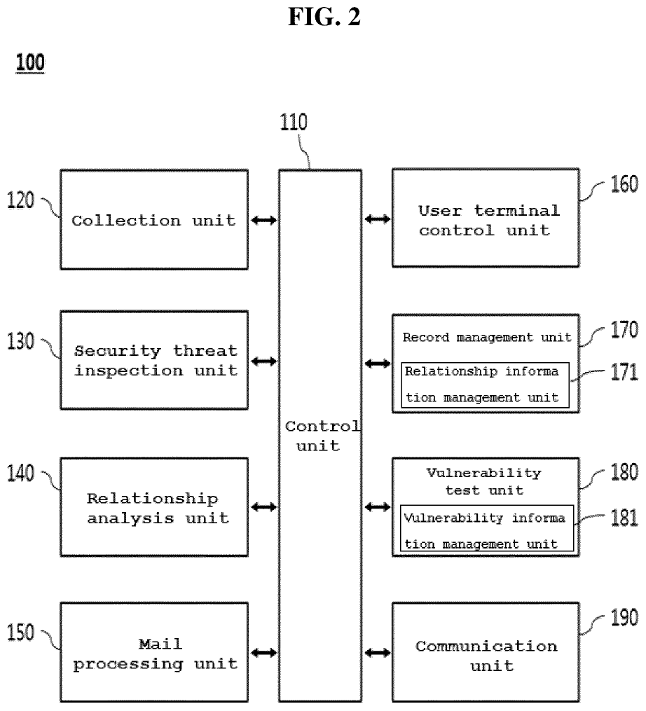

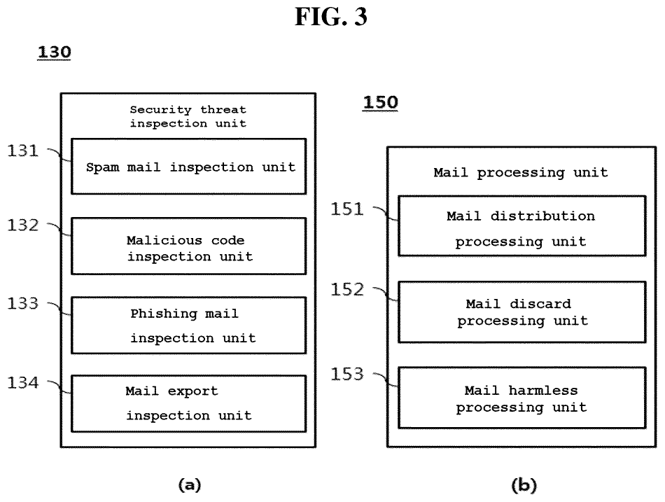

FIGS. 2 and 3 are block diagrams showing an apparatus for providing a mail security service according to an embodiment of the present invention.

Referring to FIGS. 2 and 3, the service providing apparatus 100 according to an embodiment of the present invention may include a control unit 110, a collection unit 120, a security threat inspection unit 130, a relationship analysis unit 140, a mail processing unit 150, a user terminal control unit 160, a record management unit 170, a vulnerability test unit 180, and a communication unit 190.

The control unit 110 may be implemented as one or more processors for overall control of the operation of each component in the service providing apparatus 100.

The collection unit 120 may collect mail information transmitted and received between one or more user terminals 200. The mail information may include email header information, an email subject, an email message body, the number of times of receiving mail during a predetermined period, and the like.

Specifically, the email header information may include the IP address of the mail sending server, information on the host name of the mail sending server, information on the mail domain of the sender, the mail address of the sender, the IP address of the mail receiving server, information on the host name of the mail receiving server, information on the mail domain of the recipient, the mail address of the recipient, information on the protocol of the mail, information on the time of receiving the mail, information on the time of sending the mail, and the like.

In addition, the email header may include network path information required in the process of sending and receiving mail, information on the protocol used between mail service systems for exchanging mail, and the like.

Additionally, the mail information may include an extension of an attached file, hash information of the attached file, a name of the attached file, a contents body of the attached file, uniform resource locator (URL) information, and the like. The attached file may include additional contents for transferring additional information or requesting reply of information, in addition to the message body of the mail that the sender desires to transfer to the recipient.

The contents may provide text, images, videos, and the like. The recipient may confirm the contents by executing an application corresponding to the file attached to the mail. In addition, the recipient may download the file attached to the mail to a local storage device to store and manage therein.

The extension of an attached file may distinguish a file format or type. The extension of an attached file may be generally distinguished by a character string indicating file attributes or an application creating the file. For example, a text file may be distinguished by an extension such as [file name].txt, an MS-word file by [file name].doc (docx), and a Hangul file by [file name].hwp. In addition, the extension of an image file may be classified into gif, jpg, png, tif, and the like.

Additionally, an execution file, which is a computer file performing a task directed according to a coded command, may be classified into [filename].com, [filename].exe, [filename].bat, [filename].dll, [filename].sys, [filename].scr, and the like.

The hash information of the attached file may guarantee integrity of information by inspecting forgery and alteration of the information. The hash information or hash value may be mapped to a bit string of a predetermined length for arbitrary data having a predetermined length through a hash function.

Through this, hash information output through the hash function for the initially created attached file has a unique value. The output hash information or hash value has a unidirectionality that does not allow extraction of data inversely input into the function. In addition, the hash function may guarantee avoidance of collision that cannot be accomplished by calculation of another input data that provides an output the same as the hash information or hash value output for one given input data. Accordingly, when data of the attached file is changed or added, the hash function returns a different output value.

As the unique hash information of the attached file allows comparison of hash information or hash value for a file exchanged through a mail in this way, modification, forgery, alteration of the file can be confirmed. In addition, since the hash information is fixed as a unique value, preventive measures can be taken in advance by utilizing reputation information, which is a database of history for the files created with a malicious intention. Additionally, the hash function may be used in a technique and version that can guarantee unidirectionality and collision avoidance.

For example, the hash information may be used as information for searching for existence of a malicious code in a file through a Virus Total website or a Malwares website. Information such as a file provider, a hash value of a file, and the like may be provided through a website that provides analysis of hash information of the file. In addition, as a result of searching for the hash information of a file may be used to cross-check the reputation information determined by global companies that provide a number of IT information security solutions, it is possible to determine with more reliable information.

According to a preset security threat architecture, the security threat inspection unit 130 may process step-by-step matching of a mail security process corresponding to the mail information, inspect the mail information by the matching-processed mail security process, and store and manage mail security inspection information according to a result of the inspection.

The security threat architecture may be classified into a spam mail security threat, a malicious code security threat, a social engineering security threat, and an internal information leakage security threat. The type, level, process, priority, and processing order of the security threats may be set by the security threat architecture.

The mail security process corresponding to the security threat architecture may include a spam mail security process, a malicious code security process, a phishing mail security process, and a mail export security process.

As for the mail security process, a different mail security process corresponding to an incoming mail or an outgoing mail may be determined according to the security threat architecture. In addition, the inspection order or inspection level of the mail security process may be determined by a preset security level and architecture.

In the mail security process, a flexible resource allocation method of allocating an independently classified process as a resource when mail information for receiving or sending mail is transmitted from the user terminal 200, and immediate execution of the process in an inspection area allocated from the mail information may be explained as the concept of a virtual space. In the method of allocating resources in a virtual space, when the process is completed, the mail security process may immediately process the work in the inspection area allocated from mail information that flows in sequentially.

Contrarily, when a requested task is processed, a virtual environment, i.e., an environment in which a predetermined process of which the processing is limited within a single resource is assigned like a virtual machine, may have an idle time in which other processes wait until a specific process is completed. In a method of analyzing through a process like this, flexible resources may have an advantage in processing speed and performance in comparison with fixed resources.

The security threat inspection unit 130 may classify mails by reception or transmission purposes according to the mail information collected by the collection unit 120. Thereafter, the security threat inspection unit 130 may acquire mail security inspection information for each mail by matching and analyzing the mail security process sequentially or based on a set priority.

The spam mail security threat may include mail types unilaterally and indiscriminately distributed to unspecified many people in large quantities for the purpose of advertisement, public relations, and the like between unrelated senders and receivers. In addition, a large quantity of spam mails may impose load on the data processing power of the mail system and lower the processing capability of the system. In addition, the spam mail has a risk in that users may be unintentionally linked to indiscriminate information included in the message body or the like, and it may be disguised as information for potential phishing scam.

The security threat inspection unit 130 may include a spam mail inspection unit 131 to detect and filter spam mails like this. The spam mail inspection unit 131 may match, when the mail security process is a spam mail security process, the mail information including mail header information, mail subject, mail message body, the number of times of receiving mail during a predetermined period, and the like to preset spam indexes step by step.

The spam mail inspection unit 131 may use mail information including mail header information, mail subject, mail message body, and the like as inspection items in the spam indexes through a predetermined pattern inspection or the like that may classy a mail as a spam mail. Through this, the spam mail inspection unit 131 may acquire, store, and manage spam mail inspection information by matching the spam indexes step by step.

Inspection items based on the items included in the mail information and level values obtained through inspection may be set in steps as the spam indexes. According to an embodiment of the present invention, the spam indexes may be subdivided and configured in steps of Level 1, Level 2, Level 3, . . . , Level [n].

Spam index level 1 may match mail subject data included in the mail information on the basis of big data and reputation information. Through this, an evaluated level value may be acquired as inspection information of spam index level 1. The level value may be set as information that can be quantitatively measured. For example, when the mail subject, which is an inspection item, includes a phrase such as ‘advertisement’, ‘public relations’, or the like, and matches the information defined as a spam mail in the big data and reputation information, the inspection information of spam index level 1 may be evaluated as ‘1’ among the level values classified into 0 and 1. Through this, inspection information of spam index level 1 may be acquired as ‘1’.

Additionally, spam index level 2 may match data included in the mail information on the basis of user-designated keywords. Through this, an evaluated level value may be acquired as inspection information of spam index level 2. For example, when the mail message body, which is an inspection item, includes a keyword including ‘Special price’, ‘Super special price’, ‘Bargain’, ‘Sale’, ‘Sold out’, or the like, and matches the information defined as a spam mail in the user-designated keywords, the inspection information of spam index level 2 may be evaluated as ‘1’ among the level values classified into 0 and 1. Through this, inspection information of spam index level 2 may be acquired as ‘1’.

As the next step, spam index level 3 may match data included in the mail information on the basis of image analysis. Through this, an evaluated level value may be acquired as inspection information of spam index level 3. For example, when data extracted by analyzing an image included in the mail message body, which is an inspection item, includes a phone number starting with ‘080’, and matches the information defined as a spam mail in the image analysis, the inspection information of spam index level 3 may be evaluated as ‘1’ among the level values classified into 0 and 1. Through this, inspection information of spam index level 3 may be acquired as ‘1’.

In this way, the inspection information acquired in units of spam index levels through the spam mail security process may be finally summed up as ‘3’ and stored and managed as spam mail inspection information. The spam mail inspection information summed up in this way may be included and managed in the mail security inspection information, and may be used as security threat determination information in the mail processing unit 150.

The security threat inspection unit 130 may further include a malicious code inspection unit 132. When the mail security process is a malicious code security process, the malicious code inspection unit 132 may match the mail information, further including the extension of the attached file, hash information of the attached file, the name of the attached file, the contents body of the attached file, uniform resource locator (URL) information, and the like, to a preset malicious code index step by step.

The malicious code inspection unit 132 may use the contents body of the attached file and the uniform resource locator (URL) information included in the message body, together with the extension of the attached file, hash information of the attached file, the name of the attached file, and the like, which can be confirmed from the attribute values of the attached file, as malicious code index inspection items. Through this, the malicious code inspection unit 132 may acquire, store, and manage malicious code inspection information by matching the malicious code indexes step by step according to the items.

Inspection items based on the items included in the mail information and level values obtained through inspection may be set as the malicious code indexes step by step. According to an embodiment of the present invention, the malicious code indexes may be subdivided and configured in steps of Level 1, Level 2, Level 3, . . . , Level [n].

Malicious code index level 1 may match the name of the attached file or the extension of the attached file included in the mail information on the basis of big data and reputation information. Through this, an evaluated level value may be acquired as inspection information of malicious code index level 1. For example, when the name of the attached file or the extension of the attached file, which are inspection items, includes ‘Trojan’ or ‘exe’, and matches the information defined as a malicious code in the big data and reputation information, the inspection information of malicious code index level 1 may be evaluated as ‘1’ among the level values classified into 0 and 1. Through this, inspection information of malicious code index level 1 may be acquired as ‘1’.

Additionally, malicious code index level 2 may match hash information of the attached file of a mail on the basis of big data and reputation information. Through this, an evaluated level value may be acquired as inspection information of malicious code index level 2. For example, when the hash information of the attached file, which is an inspection item, is analyzed as ‘a1b2c3d4’, and matches the information defined as a malicious code in the reputation information, the inspection information of malicious code index level 2 may be evaluated as ‘1’ among the level values classified into 0 and 1. Through this, inspection information of malicious code index level 2 may be acquired as ‘1’.

As the next step, malicious code index level 3 may match uniform resource locator (URL) information included in the attached file or the mail message body on the basis of URL reputation information. Through this, an evaluated level value may be acquired as inspection information of malicious code index level 3. For example, when the URL information, which is an inspection item, is confirmed as ‘www.malicious-code.com’, and matches the information defined in the URL reputation information as a harmful site including a malicious code file, the inspection information of malicious code index level 3 may be evaluated as ‘1’ among the level values classified into 0 and 1. Through this, inspection information of malicious code index level 3 may be acquired as ‘1’. In addition, the malicious code inspection unit 132 may respond to zero-day attacks that may be omitted in the URL reputation information. The malicious code inspection unit 132 may change a link IP address for a URL without having reputation information to an IP address of a specific system and provide the changed IP address to the user terminal 200. When the user terminal 200 desires to access the URL, it may access the IP address of the specific system changed by the malicious code inspection unit 132. The specific system that has been previously changed to a link IP address for the URL may continuously inspect whether or not a malicious code is included up to the endpoint of the URL.

In this way, the inspection information acquired in units of malicious code index levels through the malicious code security process may be finally summed up as ‘3’ and stored and managed as malicious code inspection information. The malicious code inspection information summed up in this way may be included and managed in the mail security inspection information, and may be used as security threat determination information in the mail processing unit 150.

The security threat inspection unit 130 may further include a phishing mail inspection unit 133. The phishing mail inspection unit 133 may match, when the mail security process is a phishing mail security process, relationship analysis information acquired through the relationship analysis unit 140 to a preset relationship analysis index step by step. The relationship analysis information may be acquired through analysis of the mail information including mail information and attribute information of a mail confirmed as normal.

The phishing mail inspection unit 133 may use the incoming mail domain, outgoing mail domain, incoming mail address, outgoing mail address, mail routing information, mail message body information, and the like, which can be extracted from a mail determined as normal, as relationship analysis index inspection items. Through this, the phishing mail inspection unit 133 may acquire, store, and manage phishing mail inspection information by matching the relationship analysis indexes step by step according to the items. Through this, the phishing mail inspection unit 133 may detect similar domains and filter mails that may pose a security threat by tracing or verifying mail delivery routes.

Inspection items based on the relationship analysis information and level values obtained through inspection may be set as the relationship analysis indexes step by step. According to an embodiment of the present invention, the relationship analysis indexes may be subdivided and configured in steps of Level 1, Level 2, Level 3, . . . , Level [n].

Relationship analysis index level 1 may match the domain of the sender's mail, the address of the sender's mail, and the like on the basis of reputation information. Through this, an evaluated level value may be acquired as inspection information of relationship analysis index level 1. For example, when the domain of an outgoing mail is ‘@phishing.com’ and the sender's mail address includes ‘phishing@’, which are inspection items, and matches the information defined as a malicious code in the reputation information, the inspection information of relationship analysis index level 1 may be evaluated as ‘1’ among the level values classified into 0 and 1.

Additionally, relationship analysis index level 2 may match the domain of the sender's mail, the address of the sender's mail, and the like on the basis of the relationship analysis information. Through this, an evaluated level value may be acquired as inspection information of relationship analysis index level 2. For example, when the domain of an outgoing mail is ‘@phishing.com’ and the sender's mail address includes ‘phishing@’, which are inspection items, and does not match the information defined as attribute information of a normal mail in the relationship analysis information, the inspection information of relationship analysis index level 2 may be evaluated as ‘1’ among the level values classified into 0 and 1. Through this, inspection information of relationship analysis index level 3 may be acquired as ‘1’.

As the next step, relationship analysis index level 3 may match mail routing information or the like on the basis of the relationship analysis information. Through this, an evaluated level value may be acquired as inspection information of relationship analysis index level 3. For example, when the mail routing information, which is an inspection item, is confirmed as ‘1.1.1.1’, ‘2.2.2.2’, and ‘3.3.3.3’, and the routing information, which is the mail transmission path, does not match the information defined as attribute information of a normal mail in the relationship analysis information, the inspection information of relationship analysis index level 3 may be evaluated as ‘1’ among the level values classified into 0 and 1. Through this, inspection information of relationship analysis index level 3 may be acquired as ‘1’.

In this way, the inspection information acquired in units of relationship analysis index levels through the phishing mail security process may be finally summed up as ‘3’ and stored and managed as phishing mail inspection information. The phishing mail inspection information summed up in this way may be included and managed in the mail security inspection information, and may be used as security threat determination information in the mail processing unit 150.

The security threat inspection unit 130 may include a mail export inspection unit 134 to respond to internal information leakage security threats. The mail export inspection unit 134 may match, when the mail security process is a mail export security process, mail information to a preset mail export management index on the basis of the mail information step by step.

The mail export inspection unit 134 may use the attribute information of the mail information as a mail export management index inspection item. In addition, the management index inspection item may use internally managed information on the IP address assigned to the user terminal 200.

Inspection items set in advance and level values obtained through inspection may be set in steps as the mail export management indexes. According to an embodiment of the present invention, the mail export management indexes may be subdivided and configured in steps of Level 1, Level 2, Level 3, . . . , Level [n].

The mail export management index may include an item for controlling to register only allowed IP addresses among the IP addresses assigned to the user terminal 200 as mail information for the inspecting the outgoing environment. Since an unauthenticated user terminal is likely to leak internal information and likely to pose a security threat through a mail, management indexes for preventing the leakage and threat may be managed.

In addition, the mail export inspection unit 134 may classify the mail export management indexes into inspection items such as information on the IP address, information on the number of times of transmission, and the like. In addition, the mail export inspection unit 134 may reduce the threat of internal information leakage by additionally including a control unit, such as an approval process or the like, as an item for inspecting the outgoing environment of mail. Through this, the mail export inspection unit 134 may store and manage level values, calculated by matching the inspection item through the mail export process, as mail export inspection information.

The relationship analysis unit 140 may store and manage relationship analysis information acquired through analysis of the mail information and the trust authentication log. When the record management unit 170 processes mail information as a normal mail according to the security threat determination information, the trust authentication log may include record information including the incoming mail domain, outgoing mail domain, incoming mail address, outgoing mail address, mail routing information, mail message body information, and the like.

The mail processing unit 150 may process a mail state according to security threat determination information acquired through analysis of the mail security inspection information and the mail information.

The mail processing unit 150 may perform the mail security process according to a preset priority. When the security threat determination information acquired through the mail security process is determined as an abnormal mail, the mail processing unit 150 may process the mail state by determining whether or not to stop subsequent mail security processes. Through this, when a problem is found first at the inspection step, the mail processing unit 150 may perform only the processes needed at the inspection step according to the priority, determine whether or not to stop the inspection, and terminate the process without performing subsequent inspection steps. Through this, complexity of the system can be reduced and processing efficiency can be improved by securing efficiency of the mail security service.

Information acquired by combining spam mail inspection information, malicious code inspection information, phishing mail inspection information, and mail export inspection information calculated by the security threat inspection unit 130 may be used as the mail security inspection information. For example, when the score calculated from the spam mail inspection information is ‘3’, the score calculated from the malicious code inspection information is ‘2’, the score calculated from the phishing mail inspection information ‘1’, and the score calculated from the mail export inspection information is ‘0’, the score summed up as the mail security inspection information through the process performed on the mail information by the security threat inspection unit 130 may be acquired as ‘7’. At this point, the mail may be classified as a normal mail when the overall score is in a range of 0 to 3 on the basis of the preset security threat determination information, as a gray mail when the overall score is in a range of 4 to 6, and as an abnormal mail when the overall score is in a range of 7 to 12. Accordingly, a mail of which the mail security inspection information is ‘7’ may be determined as an abnormal mail. In addition, a result value of each inspection information item included in the information on mail information inspection may be assigned with an absolute priority according to the item, or the priority may be determined by the information according to a weight.

The mail processing unit 150 may include a mail distribution processing unit 151 for processing a mail determined as a normal mail according to the security threat determination information to put the mail into a receiving or sending state that can be processed by the user terminal.

In addition, the mail processing unit 150 may further include a mail discard processing unit 152 for processing a mail determined as an abnormal mail according to the security threat determination information to put the mail into a state that does not allow access of the user terminal.

In addition, the mail processing unit 150 may further include a mail harmless processing unit 153 for converting a mail determined as a gray mail according to the security threat determination information into non-execution file contents, and providing the non-execution file contents so that the user terminal may selectively process the mail state.

Generally, a gray mail may be classified into a spam mail or a junk mail, or may be classified as a normal mail on the contrary. In the present invention, the gray mail may be defined as a mail type that is classified when the security threat determination information is calculated as a medium value in a predetermined range, which cannot be determined as normal or abnormal. The mail harmless processing unit 153 may convert the gray mail including the message body of suspicious contents into an image file and provides the mail in a state that the user terminal 200 may confirm. In addition, the mail harmless processing unit 153 may remove or modify a part in an attached file being suspicious of a malicious code and provide the mail to the user terminal 200.

The user terminal control unit 160 may control transmission of mail information when the Internet Protocol (IP) address information used by the user terminal 200 in the network corresponds to an unauthorized IP address set in advance.

The record management unit 170 may store and manage the mail information processed according to the security threat determination information as record information. The record management unit 170 may further include a relationship information management unit 171 for storing and managing, when a mail is processed as a normal mail according to the security threat determination information, the record information including the incoming mail domain, outgoing mail domain, incoming mail address, outgoing mail address, mail routing information, mail message body information, and the like as a trust authentication log. Through this, the trust authentication log may be used for reliable relationship information analysis on the recipient's and sender's mail information. In addition, reliability of the information included in the trust authentication log can be guaranteed as data are continuously accumulated through exchange of information therebetween.

In addition, when a mail is processed as an abnormal mail according to the security threat determination information, the record management unit 170 may use the record information including the incoming mail domain, outgoing mail domain, incoming mail address, outgoing mail address, mail routing information, mail message body information, and the like as an index for determining an abnormal mail when the mail security process is performed.

The vulnerability test unit 180 may convert a mail determined as an abnormal mail according to the security threat determination information into non-execution file contents, and provide the non-execution file contents so that the user terminal may receive or transmit. The vulnerability test unit 180 may include a vulnerability information management unit 181 for acquiring identification information of the user terminal receiving or transmitting the abnormal mail, and storing and managing the identification information as vulnerability information of each type.

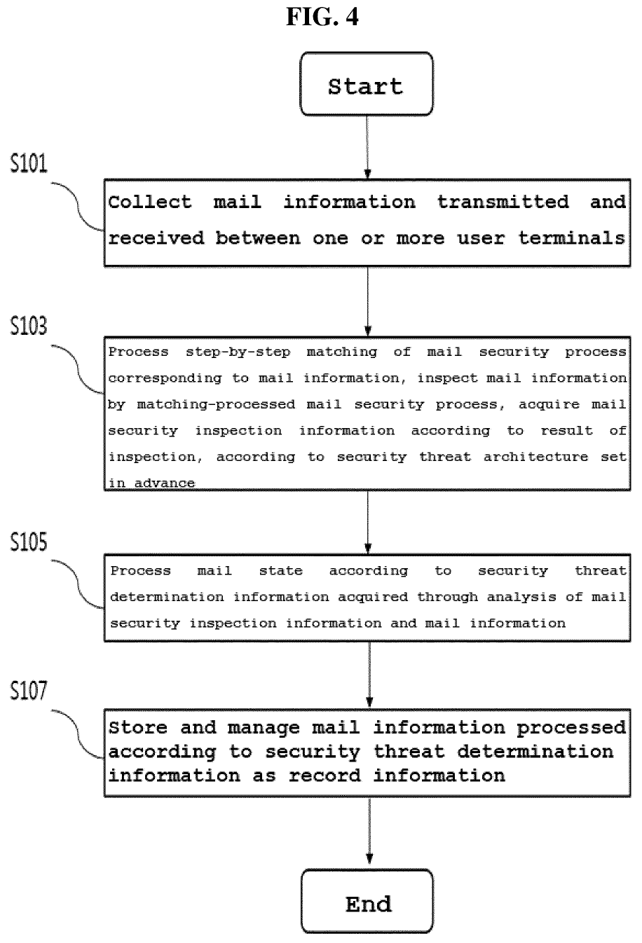

FIG. 4 is a flowchart illustrating a method of operating an apparatus for providing a mail security service according to an embodiment of the present invention.

Referring to FIG. 4, in the method of operating an apparatus for providing a mail security service, a collection step (S101) may be collected information on the mail transmitted and received between one or more user terminals 200.

A security threat inspection step (S103) may process step-by-step matching of a mail security process corresponding to the mail information according to a preset security threat architecture. Thereafter, the security threat inspection step (S103) may inspect the mail information by the matching-processed mail security process. Through this, the security threat inspection step (S103) may store and manage mail security inspection information according to a result of the inspection.

In the mail security process, a different mail security process corresponding to an incoming mail or an outgoing mail may be determined according to the security threat architecture. In addition, the inspection order or inspection level of the mail security process may be determined by a preset security level and architecture.

A mail processing step (S105) may process a mail state according to security threat determination information acquired through analysis of the mail security inspection information and the mail information.

The mail processing step (S105) may perform the mail security process according to a preset priority. When the security threat determination information acquired through the mail security process is determined as an abnormal mail, the mail processing step (S105) may process the mail state by determining whether or not to stop subsequent mail security processes. Through this, when a problem is found first at the inspection step, the mail processing step (S105) may perform only the processes needed at the inspection step according to the priority, determine whether or not to stop the inspection, and terminate the process without performing subsequent inspection steps. Through this, complexity of the system can be reduced and processing efficiency can be improved by securing efficiency of the mail security service.

The record management step (S107) may store and manage the mail information processed according to the security threat determination information as record information. The record management step (S107) may further include a relationship information management step of storing and managing, when a mail is processed as a normal mail according to the security threat determination information, the record information including the incoming mail domain, outgoing mail domain, incoming mail address, outgoing mail address, mail routing information, mail message body, and the like as a trust authentication log.

A relationship analysis step (not shown) may store and manage relationship analysis information acquired through analysis of the mail information and the trust authentication log.

The spam mail inspection step (S103) may further include a spam mail inspection step of matching, when the mail security process is a spam mail security process, the mail information, including one or more among email header information, email subject, email message body, and the number of times of receiving mail during a predetermined period, to preset spam indexes step by step. Additionally, the spam mail inspection step (S103) may further include a malicious code inspection step of matching, when the mail security process is a malicious code security process, the mail information, including one or more among the extension of the attached file, hash information of the attached file, the name of the attached file, the contents body of the attached file, uniform resource locator (URL) information, and the like, to a preset malicious code index step by step. The security threat inspection step (S103) may further include a phishing mail inspection step of matching, when the mail security process is a phishing mail security process, relationship analysis information to a preset relationship analysis index step by step. In addition, the security threat inspection step (S103) may further include a mail export inspection step of matching, when the mail security process is a mail export security process, mail information to a preset mail export management index on the basis of the mail information step by step.

The mail processing step (S105) may further include a mail distribution processing step of processing a mail determined as a normal mail according to the security threat determination information to put the mail into a receiving or sending state that can be processed by the user terminal. In addition, the mail processing step (S105) may further include a mail discard processing step of processing a mail, which is determined as an abnormal mail according to the security threat determination information, to put the mail into a state that does not allow access of the user terminal.

Additionally, the mail processing step (S105) may further include a mail harmless processing step of converting a mail determined as a gray mail according to the security threat determination information into non-execution file contents, and providing the non-execution file contents so that the user terminal may selectively process the mail state.

A vulnerability test step (not shown) may convert a mail determined as an abnormal mail according to the security threat determination information into non-execution file contents, and provide the non-execution file contents so that the user terminal may receive or transmit. The vulnerability test step may further include a vulnerability information management step of acquiring identification information of the user terminal that has received or transmitted the abnormal mail, and storing and managing the identification information as vulnerability information of each type.

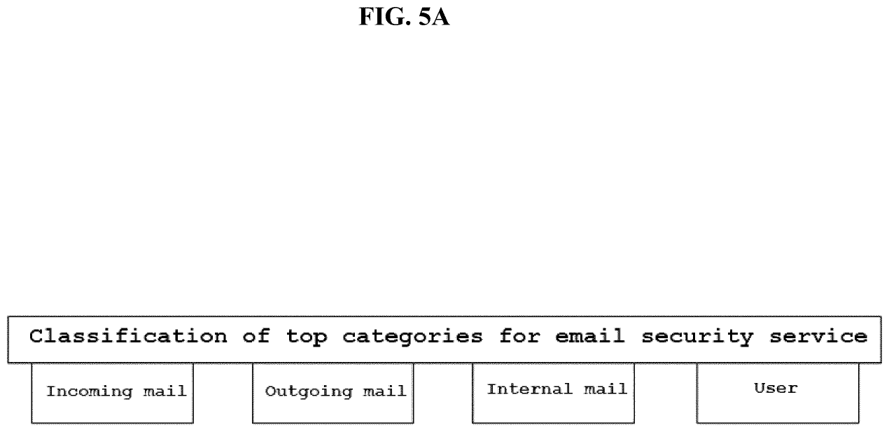

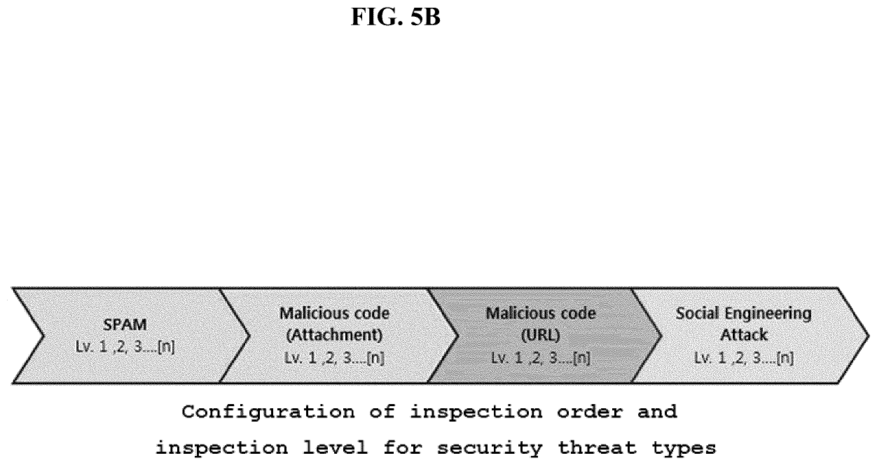

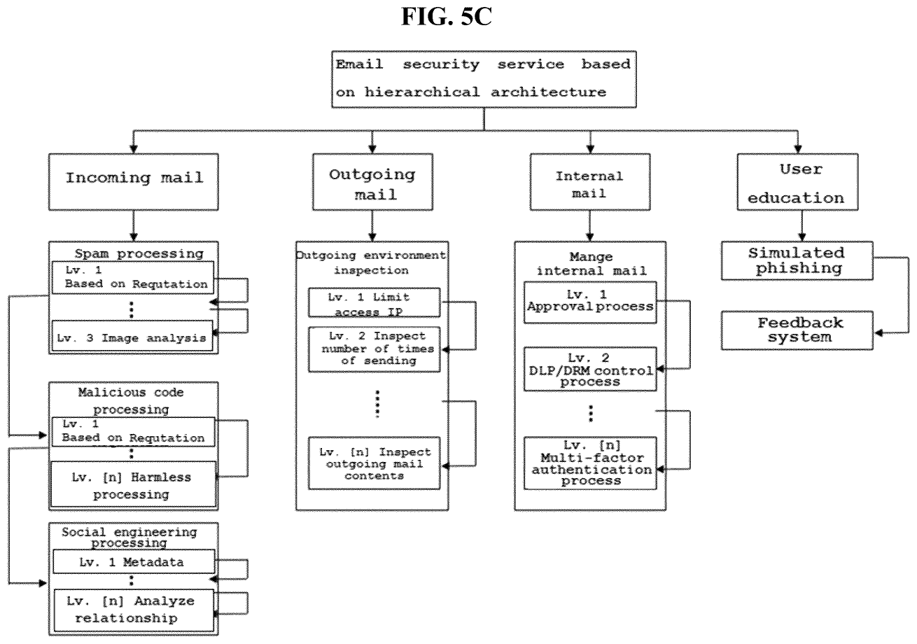

FIGS. 5A, 5B, and 5C are exemplary views for explaining an inspection method according to an architecture of a mail security service according to an embodiment of the present invention.

Referring to FIGS. 5A, 5B, and 5C, it is an architecture for providing a mail security service, and the type and level, process, priority, processing order, and the like of security threats may be set according thereto. The architecture of the mail security service is divided into top categories such as incoming mail, outgoing mail, internal mail, user education, and the like, and the hierarchical and step-by-step configuration and processing method may be applied to each category as a substructure. The top categories may be classified on the basis of the attribute values included in the mail information or on the basis of classification of systems to be accessed according to the purpose of using the mail by the user terminal 200.

One or more specific mail security processes may be assigned within each security threat type, and the mail security processes may be divided into levels and sequentially executed step by step. Specifically, the security threat types may be classified into spam, malicious code (attachment), malicious code (URL), social engineering attack, and the like. A process of inspecting the security threat type according thereto may be sequentially performed. In addition, the inspection processes may be divided into steps of level 1, 2, 3, . . . [n] in each security threat type to be performed sequentially. At this point, an inspection result may be acquired as specific inspection items and indexes are assigned to each level.

In addition, according to setting of the architecture, the mail security process in each security threat type may also be performed in a way of processing allocated inspection areas in parallel.

The security threat type of the incoming mail, which is one of the top categories, may be divided into sublayers. Specifically, the security threat type may be classified into spam processing, malicious code processing, social engineering processing, and the like.

In order to inspect the security threat of an incoming mail, whether or not the incoming mail is a spam mail may be inspected on the basis of reputation at level 1 (Lv. 1) in the spam processing section. Thereafter, when no problem is found in the spam mail inspection based on reputation, whether or not the incoming mail is a spam mail may be inspected at level 2 (Lv. 2) through filtering on the basis of user-designated keywords.

After the inspection of level 2 is completed, whether or not the incoming mail is a spam mail may be inspected at level 3 (Lv. 3), which is a next step, through analysis of contents based on image. In this way, the mail security service architecture may perform inspection at each level through a specific spam filtering process within the spam processing type, and proceeds to a next level when the inspection is completed. In addition, the mail security service architecture may proceed to a malicious code processing step of determining whether or not a malicious code is included in the mail after the spam inspection of the mail through spam processing is completed.

The malicious code processing may determine whether or not a malicious code of level 1 based on reputation is included, and proceed to a next step when the mail is confirmed to be normal. When it is determined at level n (Lv. n) that an attached file may include a malicious code, the malicious code processing step may be terminated through a harmless process that modifies the execution code included in the attached file. When the malicious code processing inspection is completed, the inspection step may proceed to a social engineering processing inspection step. At the social engineering process inspection step, a response may be processed or requested according to inspection result information after executing a process of inspecting social engineering attack mail, which is based on metadata of level 1 (Lv. 1) and relationship analysis of level n (Lv. n).

The security threat type of the outgoing mail, which is one of the top categories, may be divided into sublayers. The inspection may be performed by classifying the category of the outgoing mail into steps of spam processing, malicious code processing, and social engineering processing, like the security threat type of the incoming mail.

Particularly, security threat inspection of outgoing mail may include an outgoing environment inspection step. When one or more user terminals 200 access the system for the purpose of sending mail, the outgoing environment inspection step may perform a step of level 1 (Lv. 1) of verifying whether the user terminal has an IP address allowed according to a previously registered whitelist. When the user terminal 200 authenticated through the inspection of level 1 satisfies the number of times of sending mail in less than a predetermined reference number of times, it can be determined as a normal mail and proceeds to the next step. Thereafter, whether or not the mail is normal may be verified at the step of level n (Lv. n) by inspecting the contents of the outgoing mail in advance and executing a process of determining whether or not the mail is abnormal.

An internal mail management step capable of preventing leakage of internal information to a sublayer may be performed on the internal mail, which is one of the top categories. At the internal mail management step, abnormal mail may be inspected through an approval process of level 1 (Lv. 1). The approval process may determine the risk of information leakage of a mail including internal information.

The approval process may be performed in a way of previously censoring mail contents approved sequentially by the mail management system and sent to the outside. Then, as a step of level 2 (Lv. 2), control processes of Data Loss Prevention (DLP) and Digital Rights Management (DRM) may be performed to inspect leakage of internal information. The DLP control process may detect and control a behavior of attempting to transmit information by accessing a system violating a policy without permission such as approval or the like. The DRM control process may detect and control an attempt of decrypting an encrypted internal document or attaching a decrypted file to a mail without permission such as approval or the like. Thereafter, the step of level n (Lv. n) may provide a multi-step authentication process such as step 1, step 2, and the like as a step of authenticating the user terminal 200 when a mail is to be sent. Through this, processing of normal mail can be guaranteed by blocking users who attempt snatching or stealing of account.

The user education, which is one of the top categories, may include the steps of simulated phishing and a feedback system as sublayers. At the simulated phishing step, information such as the identification value of the user terminal 200 having a history of using mail containing security threats and the number of times of using the mail may be stored and managed. A mail configured in a way actually harmless to the system or contents may be used as the security threat. Through this, the feedback system may provide statistical values calculated through the simulated phishing or result values obtained by analyzing threat levels.

The security threat inspection configured for each category may be determined by the architecture and security levels. Accordingly, the inspection order and inspection level can be determined, and abnormalities can be confirmed according to sequential inspections. In addition, the priority of the inspection order and inspection level may be set according to the architecture and security levels. When a problem is found according to the obtained inspection result, the process performed according to the priority may perform a process needed at that step and determine whether or not to terminate the inspection. The above problem can be solved by discarding or returning the mail so that the user terminal 200 may not confirm the mail when the mail is determined as a spam mail or a mail containing malicious codes. When the problems of a mail are processed through an inspection process at a specific step in this way, subsequent inspection steps or remaining inspection steps under parallel processing may be terminated without being performed.

The methods according to the present invention described above may be manufactured as a program to be executed on a computer and stored in a computer-readable recording medium, and examples of the computer-readable recording medium include ROM, RAM, CD-ROM, magnetic tapes, floppy disks, optical data storage devices and the like, and also includes those implemented in the form of a carrier wave (e.g., transmission over the Internet).

The computer-readable recording medium may be distributed in computer systems connected through a network, so that computer-readable codes may be stored and executed in a distributed manner. In addition, functional programs, codes, and code segments for implementing the method may be easily inferred by the programmers in the art to which the present invention belongs.

In addition, although preferred embodiments of the present invention have been illustrated and described above, the present invention is not limited to the specific embodiments described above, and various modified embodiments can be made by those skilled in the art without departing from the gist of the invention claimed in the claims, and in addition, these modified embodiments should not be individually understood from the spirit or perspective of the present invention.

1. A service providing apparatus comprising:
a collection unit for collecting mail information transmitted and received between one or more user terminals;
a security threat inspection unit for processing step-by-step matching of a mail security process corresponding to the mail information, inspecting the mail information by the matching-processed mail security process, and storing and managing mail security inspection information according to a result of the inspection, on the basis of a preset security threat architecture;
a mail processing unit for processing a mail state according to security threat determination information acquired through analysis of the mail security inspection information and the mail information; and
a record management unit for storing and managing the mail information processed according to the security threat determination information as record information.

2. The apparatus according to claim 1, wherein the record management unit further includes a relationship information management unit for storing and managing, when a mail is processed as a normal mail according to the security threat determination information, the record information including one or more among an incoming mail domain, an outgoing mail domain, an incoming mail address, an outgoing mail address, mail routing information, and mail message body information as a trust authentication log.

3. The apparatus according to claim 2, further comprising a relationship analysis unit for storing and managing relationship analysis information acquired through analysis of the mail information and the trust authentication log.

4. The apparatus according to claim 3, wherein the security threat inspection unit includes a spam mail inspection unit for matching, when the mail security process is a spam mail security process, the mail information, including one or more among email header information, an email subject, an email message body, and the number of times of receiving mail during a predetermined period, to preset spam indexes step by step.

5. The apparatus according to claim 4, wherein the security threat inspection unit further includes a malicious code inspection unit for matching, when the mail security process is a malicious code security process, the mail information, further including one or more among an extension of an attached file, hash information of the attached file, a name of the attached file, a contents body of the attached file, and uniform resource locator (URL) information, to a preset malicious code index step by step.

6. The apparatus according to claim 5, wherein the security threat inspection unit further includes a phishing mail inspection unit for matching, when the mail security process is a phishing mail security process, the relationship analysis information to a preset relationship analysis index step by step.

7. The apparatus according to claim 6, wherein the security threat inspection unit further includes a mail export inspection unit for matching, when the mail security process is a mail export security process, mail information to a preset mail export management index on the basis of the mail information step by step.

8. The apparatus according to claim 1, wherein the mail processing unit includes:
a mail distribution processing unit for processing a mail determined as a normal mail according to the security threat determination information to put the mail into a receiving or sending state that can be processed by the user terminal; and
a mail discard processing unit for processing a mail determined as an abnormal mail according to the security threat determination information to put the mail into a state that does not allow access of the user terminal.

9. The apparatus according to claim 8, wherein the mail processing unit further includes a mail harmless processing unit for converting a mail determined as a gray mail according to the security threat determination information into non-execution file contents, and providing the non-execution file contents so that the user terminal may selectively process the mail state.

10. The apparatus according to claim 1, further comprising a vulnerability test unit for converting a mail determined as an abnormal mail according to the security threat determination information into non-execution file contents, and providing the non-execution file contents so that the user terminal may receive or transmit.

11. The apparatus according to claim 10, wherein the vulnerability test unit includes a vulnerability information management unit for acquiring identification information of the user terminal that has received or transmitted the abnormal mail, and storing and managing the identification information as vulnerability information of each type.

12. The apparatus according to claim 4, wherein the email header information includes one or more among an IP address of a mail sending server, information on a host name of the mail sending server, information on a mail domain of a sender, a mail address of the sender, an IP address of a mail receiving server, information on a host name of the mail receiving server, information on a mail domain of a recipient, a mail address of the recipient, information on a protocol of the mail, information on a time of receiving the mail, and information on a time of sending the mail.

13. The apparatus according to claim 1, wherein as for the mail security process,
a different mail security process corresponding to an incoming mail or an outgoing mail is determined according to the security threat architecture, and
an inspection order or an inspection level of the mail security process is determined by a preset security level and architecture.

14. The apparatus according to claim 1, wherein when the security threat determination information acquired through the mail security process according to a preset priority is determined as an abnormal mail, the mail processing unit processes the mail state by determining whether or not to stop subsequent mail security processes.

15. A method of operating a service providing apparatus, the method comprising:
a collection step of collecting mail information transmitted and received between one or more user terminals;
a security threat inspection step of processing step-by-step matching of a mail security process corresponding to the mail information, inspecting the mail information by the matching-processed mail security process, and storing and managing mail security inspection information according to a result of the inspection, on the basis of a preset security threat architecture;
a mail processing step of processing a mail state according to security threat determination information acquired through analysis of the mail security inspection information and the mail information; and
a record management step of storing and managing the mail information processed according to the security threat determination information as record information.

16. The method according to claim 15, wherein the record management step further includes a relationship information management step of storing and managing, when a mail is processed as a normal mail according to the security threat determination information, the record information including one or more among an incoming mail domain, an outgoing mail domain, an incoming mail address, an outgoing mail address, mail routing information, and mail message body information as a trust authentication log.

17. The method according to claim 16, further comprising a relationship analysis step of storing and managing relationship analysis information acquired through analysis of the mail information and the trust authentication log.

18. The method according to claim 17, wherein the security threat inspection step further includes:
a spam mail inspection step of matching, when the mail security process is a spam mail security process, the mail information, including one or more among email header information, an email subject, an email message body, and the number of times of receiving mail during a predetermined period, to preset spam indexes step by step;
a malicious code inspection step of matching, when the mail security process is a malicious code security process, the mail information, including one or more among an extension of an attached file, hash information of the attached file, a name of the attached file, a contents body of the attached file, and uniform resource locator (URL) information, to a preset malicious code index step by step;
a phishing mail inspection step of matching, when the mail security process is a phishing mail security process, the relationship analysis information to a preset relationship analysis index step by step; and
a mail export inspection step of matching, when the mail security process is a mail export security process, mail information to a preset mail export management index on the basis of the mail information step by step.

19. The method according to claim 15, wherein the mail processing step further includes:
a mail distribution processing step of processing a mail determined as a normal mail according to the security threat determination information to put the mail into a receiving or sending state that can be processed by the user terminal;
a mail discard processing step of processing a mail determined as an abnormal mail according to the security threat determination information to put the mail into a state that does not allow access of the user terminal; and
a mail harmless processing step of converting a mail determined as a gray mail according to the security threat determination information into non-execution file contents, and providing the non-execution file contents so that the user terminal may selectively process the mail state.

20. The method according to claim 15, further comprising a vulnerability test step of converting a mail determined as an abnormal mail according to the security threat determination information into non-execution file contents, and providing the non-execution file contents so that the user terminal may receive or transmit.
